(19) United States
(12) Patent Application Publication
(10) Pub. No.: US 2022/0138068 A1
(43) Pub. Date: May 5, 2022

(54) COMPUTER READABLE PROGRAM CODE CHANGE IMPACT ESTIMATIONS

(71) Applicant: Hewlett-Packard Development Company, L.P., Spring, TX (US)

(72) Inventor: Rafael Dal Zotto, Porto Alegre (BR)

(73) Assignee: Hewlett-Packard Development Company, L.P., Spring, TX (US)

(21) Appl. No.: 17/418,592

(22) PCT Filed: Jul. 2, 2019
(86) PCT No.: PCT/US2019/040288

§ 371 Date: Jun. 25, 2021

(51) Int. Cl. G06F 11/30; G06F 11/34; G06F 11/32; G06F 8/71

(52) U.S. Cl. CPC G06F 11/302; G06F 11/3466; G06F 8/71; G06F 11/324; G06F 11/3409

(57) ABSTRACT

In one example in accordance with the present disclosure, a system is described. The system includes a database to maintain, for each of a number of computing devices, time-based operating characteristics and changes to computer readable program code for each of a number of computing devices. A comparator of the system, for a target computing device associated with a change to its computer readable program code, identifies from the database a similar computing device that executed a same change. An estimator of the system generates an estimated impact of the change to the target computing device based on an impact of the same change on the similar computing device.

### BACKGROUND

Computing devices form an integral part of many personal and business activities. For example, one home may have multiple computing devices including, desktop computers, laptop computers, smartphones, mobile devices, tablets, gaming systems, and countless other computing devices. Similarly, business and other entities also rely heavily on computing devices such desktop computers, laptops, servers, etc. to carry out business operations.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for estimating an impact of a change to computer readable program code, according to an example of the principles described herein.

FIG. 2 is a diagram of a use of the system for estimating an impact of a change to computer readable program code, according to an example of the principles described herein.

FIG. 3 is a flowchart of a method for estimating an impact of a change to computer readable program code, according to an example of the principles described herein.

FIG. 4 is a diagram of a use of the system for estimating an impact of a change to computer readable program code, according to an example of the principles described herein.

FIG. 5 is a flowchart of a method for estimating an impact of a change to computer readable program code, according to another example of the principles described herein.

FIG. 6 depicts a non-transitory machine-readable storage medium for estimating an impact of a change to computer readable program code, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices are a regular part of everyday life for many individuals and for almost all organizations. Computing devices are used for word processing, data analysis, information presentation, and any number of other personal or corporate functions. Computer readable program code such as operating systems or applications are installed on the computing devices to execute different functionalities. For example, a video rendering application may be installed on a computing device to provide video editing capability to a computing device. As another example, a word processing application may be installed on a computing device to provide word processing capabilities. Other types of computing devices also have applications and/or machine-readable program code installed thereon. For example, gaming systems, smart home devices, mobile phones, and tablets among others include operating systems, and various applications. A user of the device, or a manager of an organization's devices, may have control over the applications of a computing device. Inside a corporative environment or even at home, users, and in some cases the computing devices themselves, install, remove, and/or alter computer readable program code on the computing device. Often, users don't think about the consequences of installing or removing an application from a computing device. That is, a user may not be aware of whether an installation or removal of an application will make the computing device slower/faster or whether the change may cause other issues in the computing device.

Accordingly, the present specification describes the capture of telemetry data, also referred to as operating characteristic data. Such information is used by an analytical processor, using machine learning operations, to better understand the impacts on the computing devices after the computer readable program code is changed. Such a system and method provide a better understanding and allow for the prediction of the timeline of events that occur after an application is added or removed, considering device characteristics such as model, family, processor, memory and others. The created model can then be used to infer whether the target change (i.e., installation, removal, or alteration), causes issues such as performance degradation or enhancements based on historical analysis of changes to similar devices.

In some examples, the present system and method may be used in a remote-based service structure. For example, an organization may provide support for an IT manager to manage their computing device fleet and enable predictive/prescriptive actions. The IT manager may be allowed to extract, classify and group telemetry data to create contextual insights and recommendations. The present specification describes a method to create a special type of recommendation that offers insights of potential computing device degradation or enhancement, based on installing, removing, or changing computer readable program code such as applications and operating systems. This type of insight, as described throughout the present specification, may be based on collected operating characteristics from a number of computing devices which information may be grouped based on the device type (family, model and overall hardware settings and configurations). Such information may help a consumer to better understand the consequences of adding or removing applications from their device. That is, the present systems and method offer a proactive mechanism to inform users of potential system enhancements or performance degradations obtained as a consequence of application-related changes. Based on these recommendations and insights, end-users, whether it be an administrator of a computing device fleet or a user of a personal home-use computer, can decide how to proceed.

Specifically, the present specification describes a system. The system includes a database to maintain, for each of a number of computing devices, time-based operating characteristics and changes to computer readable program code for each computing device. A comparator of the system identifies from a database, for a target computing device associated with a change to its computer readable program code, a similar computing device that executed a same change. An estimator of the system generates an estimated impact of the change by the target computing device based on an impact of the same change on the similar computing device.

The present specification also describes a method. According to the method, a number of similar computing devices are identified from a database, a similar computing device being a computing device with similar operating characteristics as a target computing device associated with a change to its computer readable program code. From the number of similar computing devices, a similar computing device that has made a same change as the change associated with the target computing device is identified. The system determines an estimated impact of the change associated with the target computing device based on an impact of the same change on the similar computing device.

The present specification also describes a non-transitory machine-readable storage medium encoded with instructions executable by a processor. The machine-readable storage medium includes instructions to 1) receive an indication of a change to computer readable program code on a target computing device and 2) determine operating characteristics of the target computing device. The machine-readable storage medium also includes instructions to 1) determine, from a database, a number of similar computing devices with similar operating characteristics and 2) determine from the number of similar computing devices, any similar computing device that has made a same change as a requested change. The instructions also determine a performance impact of the same change on the similar computing device that has made the same change and generate an estimated impact on the target computing device based on the performance impact on the similar computing device that has made the same change.

Accordingly, the present system and method make users aware of potential computing device degradations, or enhancements, when installing, removing, or changing computer readable program code on that computing device. Such information is not based on generic data, rather it uses telemetry data collected from a similar computing environment and takes into consideration similar computing devices (i.e., similar device model, family and overall hardware configuration).

That is, having the system in place, an end-user will know, when installing/removing/changing computer readable program code such as an application or an operating system, what kind of computing behavior he/she might face soon. Moreover, by using machine learning, the system may be able to tell the user that other colleagues (that have a similar/identical computing device) that have made the same change faced a given degradation, or performance increase, on their computing device. Based on this information, the user can make an educated decision to continue or discontinue with the change.

Accordingly, the system and method offer a potential degradation insight, based on the change that is made, using multiple analytical services and machine learning based on similar computing devices (model and family) inside a constrained environment.

In summary, using such a system 1) provides an estimation of an impact of application changes on a target computing device; 2) is computing device-specific; 3) provides an estimation based on historical performance; 4) enhances performance by providing information from which an informed decision may be made; and 5) provides recommendations based on policies or shared behaviors. However, it is contemplated that the devices disclosed herein may address other matters and deficiencies in a number of technical areas.

As used in the present specification and in the appended claims, the term “a number of” or similar language is meant to be understood broadly as any positive number including 1 to infinity.

Further as used in the present specification and in the appended claims, the term “computer readable program code” refers to instructions used by a computing device to execute a particular functionality. One category of computer readable program code is an “application” which refers to program code that is intended for a specific purpose. Examples of applications include a word processing application, a video editing application, etc. Another category of computer readable program code is an “operating system” which manages hardware, memory, processors, processes, and other applications.

Even further, as used in the present specification and in the appended claims, the term “target computing device” refers to a computing device that has recently made a change, or that is going to make a change to its computer readable program code and for which an estimated impact is calculated.

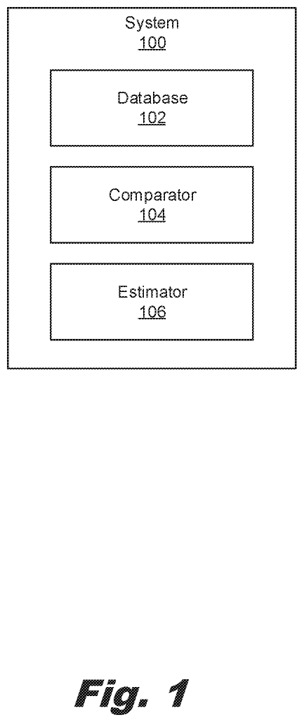

Turning now to the figures, FIG. 1 is a block diagram of a system (100) for estimating an impact of a change to computer readable program code, according to an example of the principles described herein. The system (100) may be disposed on any variety of computing devices. Such computing devices include mobile phones, desktop computers, laptop computers, servers, tablet devices, gaming systems, smart home devices, and others. As described above, these computing devices all include computer readable program code in a variety of formats. For example, computing devices may include applications to carry out a particular functionality. Examples of applications include a camera application to take pictures with an onboard camera and a word processing application to create, edit, and save word processing documents. As yet another example, an email application may be installed which facilitates email communication between parties. As yet another specific example, the computer readable program code may be an operating system for a computing device. While specific reference is made to a few types of computer readable program code, other types of computer readable program code may also be disposed on the computing device, with different applications and operating systems having a specific version.

At any given time, the computer readable program code, or collection of applications and operating system on a computing device may change. That is, over time new applications may be added, applications may be removed, and/or applications may be update. Such updates may impact the overall functionality of the computing device. Accordingly, the present system (100) allows for the tracking of such changes and provides an estimate of their impact on the target computing device.

The system (100) includes a database to maintain, for each of a number of computing devices 1) time-based operating characteristics and 2) changes to computer readable program code for each computing device. The operating characteristics may refer to any number of characteristics that define a computing device. Examples of operating characteristics include a device type, a device family, a device model, hardware components installed on the device, hardware component operating parameters, device age, hardware component age, device capability, and hardware component usage.

As specific examples, a device type may identify whether the computing device is a mobile device, laptop, desktop, gaming system, etc. A device family may indicate whether a device is a part of a related set of devices. For example, a manufacturer may group laptop devices into “families” meaning that they have similar operational objectives. As a specific example, an enterprise family of desktop computers may have a lower quality graphics card as it is anticipated that these desktop computers will be used for data analysis. As another specific example, a gaming family of desktop computers may have a high-quality graphics card. The device model may indicate the specific model of a computing device within a family. The device model may indicate a particular hardware set for a computing device.

The operating characteristics may also indicate hardware components and hardware component operating parameters. For example, the operating characteristics may indicate what memory module a computing device has and the read/write speeds of that memory module. As yet another example, the operating characteristics may indicate a computing device age and a hardware component age.

As yet another example, the operating characteristics may indicate a hardware component usage. For example, the operating characteristics may indicate a percent usage of the central processing unit (CPU) and/or the usage of the memory module. While specific reference is made to a few specific operating characteristics, other characteristics may be maintained in the database as well.

As noted above, information regarding these operating characteristics may be time-based. That is, over time some of these operating characteristics may change. For example, hardware components may be swapped in or out, the device age changes over time, and CPU usage and/or memory usage may change daily, if not more frequently. Accordingly, the database (102) may include this information for multiple computing devices, and may include a history of the operating characteristics over time. As will be described below, this information may be used to determine the effect that changes to the computer readable program code have on the computing device. For example, as an application is installed, this may affect CPU usage. Accordingly, by maintaining a database (102) of these operating characteristics, the system (100) can aid in prediction of what the impact of a subsequent, but similar, application change will have on a target computing device.

The database (102) also maintains a record of changes to computer readable program code on each of a number of computing devices. That is, as described above, a variety of changes may be made to the different applications and/or operating system on a computing device with each of these changes potentially impacting the operation of the computing device. For example, if a new, large application is installed, this may consume memory on a computing device and therefore reduce its performance. As another example, some applications are bulky and consume a lot of processing bandwidth. Accordingly, adding or removing such an application may decrease or increase, respectively, the processing capability of a target computing device.

In one example, the change to the computer readable program code is an update to an operating system of the computing device. In another example, the change is the adding, or installation, of an application for the computing device. For example, a new application with new program code may be installed on a computing device. As yet another example, the change may be the removal of an application from the computing device. That is, an existing application may be uninstalled from a computing device. As yet another example, changing the computer readable program code may be changing an application, as for example by upgrading an application or downgrading an application.

In either case, such changes affect computing device functionality and so by keeping a database (102) that records both operating characteristics and a record of changes to any of the computer readable program code of a computing device, the system (100) can predict the likely performance impact of such a change at a subsequent period of time.

In some examples, the database (102) entry for a particular computing device is indexed via program code changes. For example, the database (102) may include a number of time-based entries, each of which indicate performance or operating characteristic values for a computing device over time. As a change is made to the computer readable program code on that computing device, a flag, tag, or other metadata is indicated and timestamped. Accordingly, in determining the effect of the change of the computer readable program code, the system (100) can look to either side of the flag to determine a performance before the change and a performance after the change, thus identifying an impact of the change.

In some examples, the database (102) groups information based on at least one operating characteristic. For example, the database (102) may organize the data contained therein based on the computing device from which it is received. Data received from computing devices with similar operating characteristics may be associated in some form. As an example, data collected from multiple desktop computers may be associated with one another in the database in some fashion, for example via metadata. Such an association allows for impact estimations for a target computing device that are based on the impact of similar changes on devices that have the same operating characteristics. That is, in an example an application may be scheduled to be installed on a target computing device with a lot of processing bandwidth. Rather than basing an impact estimation on a generic computing device, the system (100) may make an estimation based just on the measured impact from computing devices with similar processing bandwidth. Thus, a customized estimation based on similar computing devices is provided, which provides a more accurate estimation. A more accurate estimation provides better information on which the system (100) or a user may rely on in determining a course of action to carry out.

In some examples, the operating characteristic data is collected daily. Accordingly, the system (100) may check for computer readable program code changes every day and act upon it. In another example, a back-end infrastructure can be modified to receive, in real-time, chunks of operating characteristics when computer readable program code is added or removed. While particular reference is made to a particular interval for operating characteristic data retrieval, any period of data retrieval may be used. In other words, regardless of how the operating characteristics are received, the system (100) processes and acts when the operating characteristic data arrives (be it daily or in real-time).

The system (100) also includes a comparator (104) to, for a target computing device associated with a change to its computer readable program code, identify from the database (102) a similar computing device that executed a same change. That is, as described above, computing devices may make changes to any of the multiple applications/operating systems installed thereon. Once a change is detected on a target computing device, or it is detected that a change is to be made, it may be determined what similar computing devices have made that same, or similar change.

Based on the information included in the database (102), the target computing device may already be associated with similar computing devices. As used in the present specification, the similar computing device may be one that has at least one similar, or the same, operating characteristic as the target computing device. For example, a similar computing device may be one that is of the same type and has a similar age. While particular reference is made to two operating characteristics (type and age) being used to determine that two computing devices are similar, any number and any combination of the above-mentioned operating characteristics may be used to determine the similarity or lack thereof of different computing devices. Moreover, the difference between the operating characteristics may be relied on in determining similarity. For example, if two computing devices have the CPU usage within a threshold range of one another, this may be factor indicating similarity/sameness.

Accordingly, as described above, when a change is indicated, the database (102) may be referenced to identify among the similar computing devices, those which have made a similar, or same, change. In some examples, the indicated change may be prior to the change being made and in other cases may be after the change is made. For example, a user may trigger an installation of an application for, by example, clicking on an “OK” button. In this example, at this point in time the comparator (104) may identify the similar computing device that has made the similar change. In another example, this indication may come after the modification is made. For example, a user of a device that is out of the network may remove an application. In this example, the indication may arrive when the computing device is back on a particular network, that is when the user is back online.

Relying on a similar, or same, computing device allows for any estimation of impact to account for particular operating characteristics of a target computing device. That is, any estimation of impact based on computing devices with dissimilar operating characteristics may not be reliable as impact is largely determined by those operating characteristics. Accordingly, by just analyzing historical information related to similar computing devices, a more accurate and reliable estimation/expectation is provided.

The system (100) also includes an estimator (106) to generate an estimated impact of the change on the target computing device based on an impact of the same change on the similar computing device. That is, as described above, the database (102) may indicate operating characteristics before and after a particular change is made. Accordingly, the estimator (106) may use this pre- and post-change information to determine the effect of such a change. As described above, the impact and estimated impact may be a performance impact and an estimated performance impact respectively. For example, before an application is installed, the similar computing devices that made the same change as the indicated change may have a CPU usage rate of 90%. These same devices after the installation may have a CPU usage rate of 95%. Accordingly, the estimated impact may indicate that the target computing device is likely to see an increased CPU usage rate of 5%.

As described above, such an estimation is based on similar computing devices that made similar changes. Thus, a user may have confidence in the reliability of this estimation as it is device-specific and not generic.

In some examples, the estimator (106) may estimate other information. For example, the estimator (106) may estimate subsequent activity related to the change based on subsequent activity related to the same change on the similar computing device. For example, the estimator (106) may determine that 3 days after a particular application was installed, the users of the similar devices removed that same application, for example due to performance degradation. Accordingly, this data may be presented to the user.

An overall example of the system (100) is now provided. In this example, a user of a Y model smartphone may trigger installation of a mobile application to edit videos captured by the smartphone. Prior to such a trigger, the Y model smartphone may periodically or continually pass data to the database (102) as are other devices, including other Y model smartphones. Accordingly, the target Y model smartphone is associated, via metadata or other mechanisms, with other Y model smartphones.

Upon an indication of the pending change, the comparator (104) may access the database (102) to find which of those other Y model smartphones had the video-editing application installed thereon. When found, the estimator (106) analyses the CPU usage and memory usage of those similar Y model smartphones right before and after the installation of the video editing application to determine a change therein. Using this pre- and post- installation information, the estimator (106) provides an indication of an estimated impact based on the determined changes to the performance of the similar Y model smartphones. Thus, the present system (100) provides an estimate that is 1) specific to the particular computing device based on similarity with other computing devices for which operating characteristic data is collected and 2) is based on actual performance changes, and not estimated performance changes.

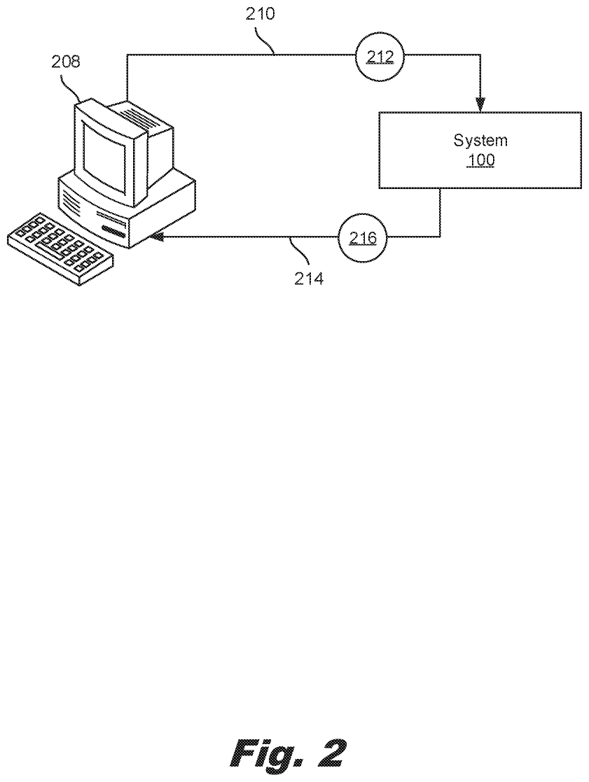

FIG. 2 is a diagram of a use of the system (100) for estimating an impact of a change to computer readable program code, according to an example of the principles described herein. As described above, the system (100) may be used to predict impact of any variety of changes to the computer readable program code stored on a computing device (208). Accordingly, the system (100) receives operating characteristic (212) data along a first path (210). As described above, the operating characteristic (212) data may include a variety of pieces of information. The system (100) organizes this operating characteristic (212) data from this computing device (208) and others to better understand the impacts, positive or negative, that an application/operating system installation, removal, or change can potentially cause to the computing device (208). Accordingly, as depicted in FIG. 2, the system (100) collects certain operating characteristic (212) data from various computing devices (208). This operating characteristic (212) data is sent to the database (FIG. 1, 102) which may be remote. The comparator (FIG. 1, 104) and estimator (FIG. 1, 106) of the system (100) analyze the deterioration of the computing device (208) (in terms of overall performance) after a given application/operating system is installed, removed, or changed considering computing devices (208) that are similar based on any number of the criteria mentioned above.

Based on the collected operating characteristic (212) data, the system (100) may generate a model (216) to be used by the computing device (208). That is, when a change to computer readable program code is detected (i.e., application is installed or removed or a system update is applied), this model is used, and an insight, such as performance impact, is passed to the computing device (208) along a second path (214). As described above, the system (100) uses the operating characteristic (212) data to gather from a number of other computing devices (208) and determines similarities including device capabilities and configurations.

That is, the system (100) parses/filters the operating characteristics (212) to identify changes and/or code added/removed or system updates. In this example, if changes are detected, the system (100) collects overall computing device (208) operating characteristics (212) data such as memory, CPU, device family, and device model among others. Such data may be used to create a model (216). The model (216) may include insights and recommendations that are based on the changes. If results are available, they are sent to the computing device (208) as messages.

As a specific example, the system may collect operating characteristic (212) data from all model A laptops from a given company. This operating characteristic (212) data has details related to the hardware configuration (including CPU and memory), overall system performance and changes done in terms of computer readable program code (updates, new applications installed and/or removed) for each model A laptop. This data, over time, leads to creation of a cause-consequence timeline from which an event correlation may be made. For example, the system (100) may determine that every computing device (208) that installed “application X” experienced a 4% increase of their CPU usage. As another insight, the system (100) may inform a user that after removing “application Z”, the number of system freezes (hence reboots) increased in 12%. Accordingly, such insights can help the user to make informed decisions to either keep, remove or restore the application.

Accordingly, the system (100) uses operating characteristic data (210) and organizes it in such a way so as to understand computing device (208) behavior based on a specific group of actions (in this case, specifically related to computer readable program code changes). Put another way, the system (100) uses the operating characteristic (212) data to train machine learning devices that could offer insights and recommendations regarding overall system performance, based on the installation, removal, or other changes to computer readable program code for a computing device.

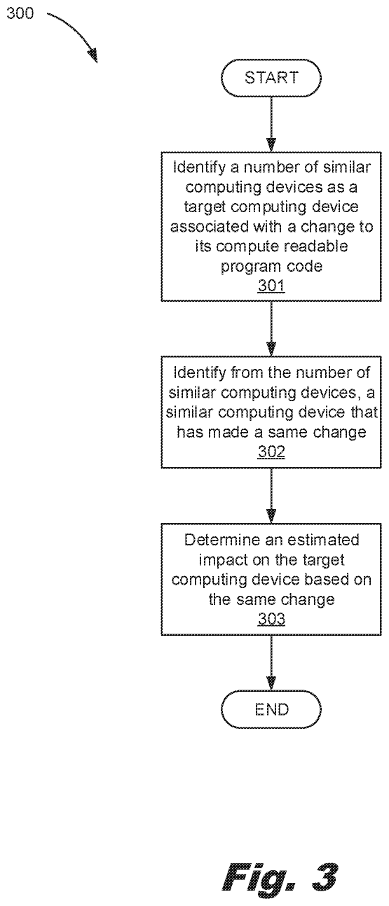

FIG. 3 is a flowchart of a method (300) for estimating an impact of a change to computer readable program code, according to an example of the principles described herein. As described above, computing devices (FIG. 2, 208) experience any number of changes to its computer readable program code ranging from updates to operating systems and updates, removals, and installations of applications, such as word processing applications, video editing applications and any number of other applications that are designated to perform a particular functionality. The present method (300) estimates the impacts of such changes to the computing device (FIG. 2, 208) as a whole.

Specifically, the method (300) includes identifying (block 302), from a database (FIG. 1, 102), a number of similar computing devices (FIG. 2, 208) with similar operating characteristics as a target computing device (FIG. 2, 208), which target computing device (FIG. 2, 208) is associated with a change to its computer readable program code. In some examples, the identification (block 302) may come before any identified change. That is, overtime the database (FIG. 1, 102) may collect operating characteristics (FIG. 2, 212) for multiple computing devices (FIG. 2, 208). As described above, such operating characteristics (FIG. 2, 212) may be varied and include any number of specific pieces of information such as those indicated above. Moreover, the criteria by which computing devices (FIG. 2, 208) are deemed similar may vary. That is, two computing devices (FIG. 2, 208) may be deemed similar if they have the same model number. In another example, two computing devices (FIG. 2, 208) may be deemed similar if they have the same processor and memory. As can be seen, computing devices (FIG. 2, 208) may be deemed as similar based on any number of similar, or the same, operating characteristics.

From the number of similar computing devices (FIG. 2, 208), the method (300) includes identifying (block 302) a similar computing device (FIG. 2, 208) that has made a same change as a change associated with the target computing device (FIG. 2, 208). That is, it may be the case that any change made, or to be made, on the target computing device (FIG. 2, 208) has been made before, and by a computing device (FIG. 2, 208) with similar operating characteristics. Such an identification (block 302) may be proactive or reactive. That is, the identification (block 302) may be that a change is to be made, but has not yet been made or the identification (block 302) may be that a change has already been made to the target computing device (FIG. 2, 208) application set.

An estimated impact of the change to the target computing device (FIG. 2, 208) is determined (block 303) based on the impact of the same change on the similar computing device (FIG. 2, 208). Specifically, the estimated impact is determined (block 303) based on the measured impact of the same change by the similar computing device (FIG. 2, 208). That is, at a first point in time a similar computing device (FIG. 2, 208) makes a change to its computer readable program code by installing, removing, or changing an application or operating system which has a measurable impact on performance. When a subsequent, i.e., the target, computing device (FIG. 2, 208) makes the same change, this measured impact is referenced to indicate what effect the change to the target computing device (FIG. 2, 208) will be. Given that the similar and target computing devices (FIG. 2, 208) have similar operating characteristics, the impact of the first change on the similar computing device (FIG. 2, 208) may be regarded as an accurate estimate of the impact the same change will have on the target computing device (FIG. 2, 208).

Determining (block 303) the estimated impact includes comparing a performance of the similar computing device before the same change with a performance of the similar computing device after the same change. Such performance may be indicated by any one of the operating characteristics for which data (FIG. 2, 210) was collected. For example, before and after a change to an application any number of the operating characteristics may change including hardware components available, CPU usage, and/or memory usage to name a few. By periodically receiving data regarding these operating characteristics, the system (FIG. 1, 100) can extract measures on either side of a time stamp associated with the change and thereby determine how that particular operating characteristic set has changed and can interpret from those changes, the likely outcome, i.e., impact, that may result from the same change made at a target computing device (FIG. 2, 208).

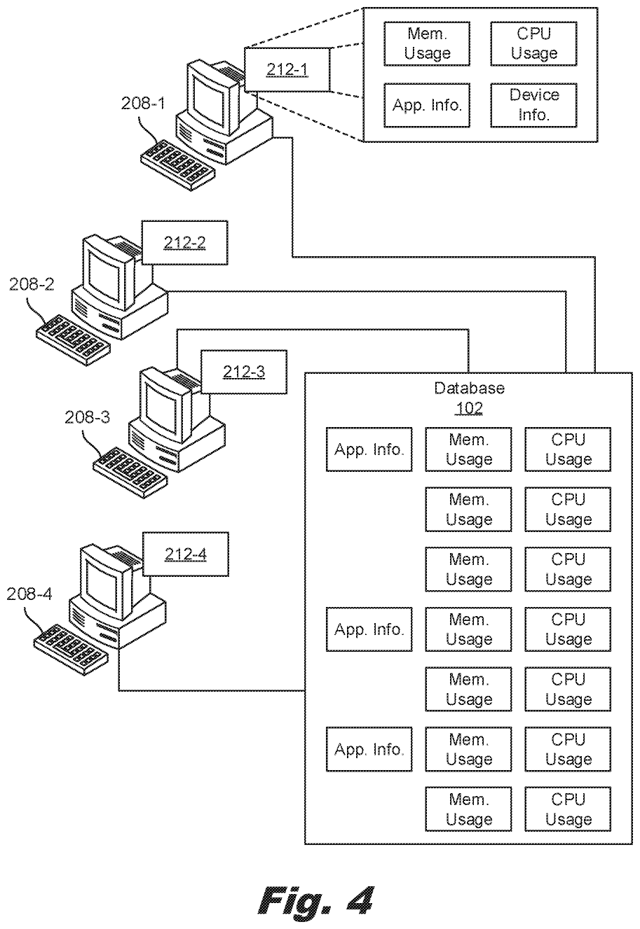

FIG. 4 is a diagram of a use of the system (FIG. 1, 100) for estimating an impact of a change to a computer readable program code, according to an example of the principles described herein. Specifically, FIG. 4, depicts multiple computing devices (208-1, 208-2, 208-3, 208-4) collecting and sending operating characteristic (212-1, 212-2, 212-3, 212-4). As described above, the operating characteristics (212) may include a variety of pieces of specific data such as percent of memory used, percent CPU usage as well as device information such as hardware components and their respective operating parameters. While specific reference is made to particular pieces of data, any number of different categories of operating characteristics (212) may be collected, and passed, per computing device (208).

The system (FIG. 1, 100) gathers this operating characteristic (212) data and organizes it in the database (102). In some examples, the computer readable program code change information is a tag, or bookmark, in the database (102). Accordingly, the changes to the computer readable program code of a computing device (208) are also passed as operating characteristics (212) to the database (102). Accordingly, the database (102) includes a group of operating characteristics (212) bookmarked by computer readable program code information. As used in the present specification and in the appended claims the term “computer readable program code refers to as a collection of relevant data from a given application. For example, the computer readable program code may include code specifications including the version and release. As described throughout the specification, this computer readable program code information can be used to filter/sort the estimations/recommendations.

As described above, the database (102) may be grouped via computing device (208). Accordingly, the database (102) allows filtering of the operating characteristics (212). For example, operating characteristics (212) could be filtered that pertain to model X laptops that installed a particular word processing application.

From this dataset and based on the timestamp, statistical data is collected regarding overall performance before and after a particular change to the computer readable program code. This is used by other computing devices (208) to gather insights. For example, based on the target computing device (208) operating characteristics (212) and the similar computing device (208) operating characteristics (212), it can be determined what is the expected result if a particular scanning application is installed on the target computing device (208).

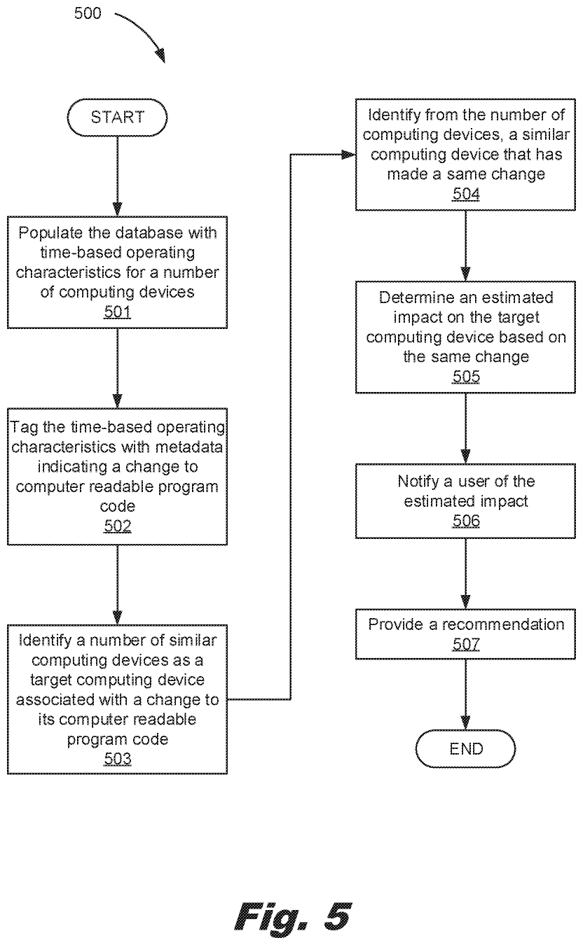

FIG. 5 is a flowchart of a method (500) for estimating an impact of a change to computer readable program code, according to another example of the principles described herein. In this example, the method (500) includes populating (block 501), per computing device (FIG. 2, 208), the database (FIG. 1, 102) with time-based operating characteristics (FIG. 2, 212) for a number of computing devices (FIG. 2, 208). That is, each computing device (FIG. 2, 208) may include a collector, or multiple collectors, to collect data from multiple sensors, installed hardware and applications from different computing devices (FIG. 2, 208). In some examples, the collector runs daily, and the produced content is organized as a payload and then transferred to the system (FIG. 1, 100). The operating characteristic (FIG. 2, 212) data produced by these collectors may be uploaded to the database (FIG. 1, 102) where it is cleaned, enriched and used as input. In some examples, these collectors use machine learning techniques such as random forests, regression, clustering and deep learning. While particular reference is made to collectors that run, and transmit information daily, the collectors may operate at different time intervals, for example per hour, minute, second, etc. and in some examples different collectors may collect at different time granularities.

In some examples, different collectors may be responsible to collect a very specific spectrum of data. For example, different collectors collect overall system usage performance (throughout the day) and details related to the installed hardware (for example, battery-specific data such as serial number, manufacturer, current capacity and warranty status to name a few). Other collectors collect data related to disk, CPU, BIOS, thermal, operating system events and updates, installed and removed applications among others.

In some examples, the method (500) also includes tagging (block 502) the time-based operating characteristics (FIG. 2, 212) with metadata indicating a change to the computer readable program code. As described above, such a tag, or bookmark, allows performance of a computing device (FIG. 2, 208) to be evaluated before and after a particular change is made such that an estimated impact may be made therefrom.

With such information on hand, a number of similar computing devices (FIG. 2, 208) may be identified (block 503) and any similar computing device (FIG. 2, 208) that made a same change is identified (block 504). These operations may be performed as described above in connection with FIG. 3. An estimated impact is then determined (block 505) based on the impact of the same change on the similar computing device (FIG. 2, 208). This also may be performed as described above in connection with FIG. 3.

With the estimated impact on hand, any number of actions may be carried out. In some examples, the action includes notifying (block 506) a user of the target computing device (FIG. 2, 208) of the estimated impact. Such a notification (block 506) may be provided in any number of ways, for example via an onscreen dialog box. As a particular example, the system (FIG. 1, 100) may identify that a particular data analytic application was installed and, based on operating characteristics (FIG. 2, 212) collected from similar computing devices (FIG. 2, 208), the system (FIG. 1, 100) determined that the installation/usage of such application causes an increase of CPU usage. This information may be presented to the user via a popup box on the display screen of the computing device (FIG. 2, 208). In some examples, in addition to providing a notification, the system (FIG. 1, 100) may provide (block 507) a recommendation to the user of the target device (FIG. 2, 208). The recommendation may be based on the estimated impact. As a specific example, along with the notification, a message may provide (block 507) a recommendation to uninstall the application.

The notification and/or recommendation could relate to a subsequent action of the similar computing device related to the change. As an example, imagine that a user removes a particular word processing application. Based on this change and based on the operating characteristic (FIG. 2, 212) data gathered from similar computing devices (FIG. 2, 208), the system (FIG. 1, 100) may present the notification/recommendation that “89% of users that removed this word processing application installed it again after 3 days”. This is another example of a notification/recommendation that may be based on operating characteristic (FIG. 2, 212) data that originated in similar computing devices (FIG. 2, 208), that executed the same change. As yet another example, the recommendation may be based on policies by a manufacturer of the computing device or a manager of a computing device fleet.

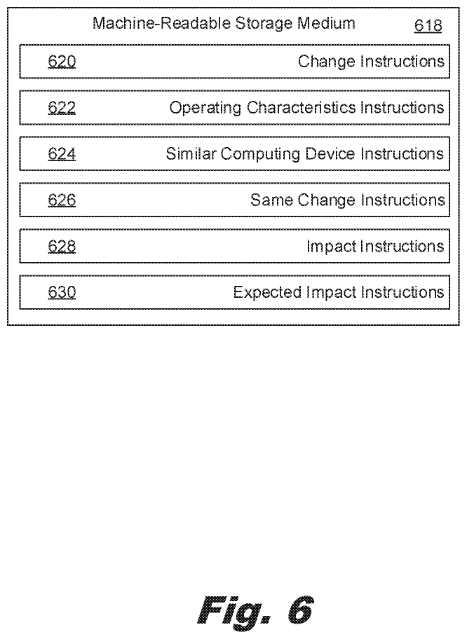

FIG. 6 depicts a non-transitory machine-readable storage medium (618) for estimating an impact of a change to computer readable program code, according to an example of the principles described herein. To achieve its desired functionality, a computing system includes various hardware components. Specifically, a computing system includes a processor and a machine-readable storage medium (618). The machine-readable storage medium (618) is communicatively coupled to the processor. The machine-readable storage medium (618) includes a number of instructions (620, 622, 624, 626, 628, 630) for performing a designated function. The machine-readable storage medium (618) causes the processor to execute the designated function of the instructions (620, 622, 624, 626, 628, 630). The machine-readable storage medium (618) can store data, programs, instructions, or any other machine-readable data that can be utilized to operate the system (FIG. 1, 100). Machine-readable storage medium (618) can store computer readable instructions that the processor can process, or execute. The machine-readable storage medium (618) can be an electronic, magnetic, optical, or other physical storage device that contains or stores executable instructions. Machine-readable storage medium (618) may be, for example, Random Access Memory (RAM), an Electrically Erasable Programmable Read-Only Memory (EEPROM), a storage device, an optical disc, etc. The machine-readable storage medium (618) may be a non-transitory machine-readable storage medium (618).

Referring to FIG. 6, change instructions (620), when executed by the processor, cause the processor to receive an indication of a change to computer readable program code on a target computing device (FIG. 2, 208). Operating characteristics instructions (622), when executed by the processor, may cause the processor to, determine operating characteristics (FIG. 2, 212) of the target computing device (FIG. 2, 208). Similar computing device instructions (624), when executed by the processor, may cause the processor to determine, from a database (FIG. 1, 102), a number of similar computing devices (FIG. 2, 208) with similar operating characteristics (FIG. 2, 212). Same change instructions (626), when executed by the processor, may cause the processor to, determine from the number of similar computing devices (FIG. 2, 208), any similar computing device (FIG. 2, 208) that has made a same change as a requested change. Impact instructions (628), when executed by the processor, may cause the processor to determine a performance impact of the same change on the similar computing device (FIG. 2, 208) that mas made the same change. As described above determining a performance impact may include determining a performance of at least one computing resource on the similar computing device before and after the same change. Expected impact instructions (630), when executed by the processor, may cause the processor to generate an estimated impact on the target computing device (FIG. 2, 208) based on the performance impact on the similar computing device (FIG. 2, 208) that has made the same change.

In summary, using such a system 1) provides an estimation of an impact of application changes on a target computing device; 2) is computing device-specific; 3) provides an estimation based on historical performance; 4) enhances performance by providing information from which an informed decision may be made; and 5) provides recommendations based on policies or shared behaviors. However, it is contemplated that the devices disclosed herein may address other matters and deficiencies in a number of technical areas.

What is claimed is:

1. A system, comprising:
a database to maintain, for each of a number of computing devices:
time-based operating characteristics; and
changes to computer readable program code for each computing device;
a comparator to, for a target computing device associated with a change to its computer readable program code, identify from the database a similar computing device that executed a same change; and
an estimator to generate an estimated impact of the change by the target computing device based on an impact of the same change on the similar computing device.

2. The system of claim 1, wherein the similar computing device shares at least one of the following operating characteristics with the target computing device:
device type;
device family;
device model;
hardware components;
hardware component operating parameters;
device age;
hardware component age;
device capability; and
hardware component usage.

3. The system of claim 1, wherein the change to the computer readable program code comprises an update to an operating system of the target computing device.

4. The system of claim 1, wherein the change to the computer readable program code comprises at least one of:
adding an application to the target computing device; and
removing an application from the target computing device.

5. The system of claim 1, wherein the database groups time-based operating characteristics based on at least one operating characteristic.

6. The system of claim 1, wherein the impact and estimated impact indicate a performance impact and an expected performance impact, respectively.

7. A method, comprising:
identifying, from a database, a number of similar computing devices with similar operating characteristics as a target computing device associated with a change to its application set;
from the number of similar computing devices, identifying a similar computing device that has made a same change as a change associated with the target computing device; and
determining an estimated impact of the change associated with the target computing device based on an impact of the same change on the similar computing device.

8. The method of claim 7, further comprising notifying a user of the target computing device of the estimated impact.

9. The method of claim 7, further comprising providing a recommendation to a user of the target device.

10. The method of claim 9, wherein the recommendation is based on at least one of:
the estimated impact; and
a subsequent action of the similar computing device related to the same change.

11. The method of claim 7, wherein determining an estimated impact comprises comparing a performance of the similar computing device before the same change with a performance of the similar computing device after the same change.

12. The method of claim 7, further comprising populating, per computing device, the database with time-based operating characteristics for a number of computing devices.

13. The method of claim 12, further comprising tagging the time-based operating characteristics with metadata indicating a change to the computer readable program code.

14. A non-transitory machine-readable storage medium encoded with instructions executable by a processor, the machine-readable storage medium comprising instructions to:
receive an indication of a change to computer readable program code on a target computing device;
determine operating characteristics of the target computing device;
determine, from a database, a number of similar computing devices with similar operating characteristics;
determine from the number of similar computing devices, any similar computing device that has made a same change as a requested change;
determine a performance impact of the same change on the similar computing device that has made the same change; and
generate an estimated impact on the target computing device based on the performance impact on the similar computing device that has made the same change.

15. The non-transitory machine-readable storage medium of claim 14, wherein determining a performance impact comprises determining a performance of at least one computing resource on the similar computing device before and after the same change.
